(19) United States
(12) Patent Application Publication
(10) Pub. No.: US 2009/0325101 A1
(43) Pub. Date: Dec. 31, 2009

(54) Method for Producing Toner

(75) Inventors: Jun Ikami, Nagoya-shi (JP); Masateru Kawamura, Toyoake-shi (JP); Kazutoshi Kotama, Toyota-shi (JP)

Correspondence Address: BANNER & WITCOFF, LTD.;ATTORNEYS FOR CLIENT NO. 016689, 1100 13th STREET, N.W., SUITE 1200, WASHINGTON, DC, 20005-4051, US

(73) Assignee: Brother Kogyo Kabushiki Kaisha, Nagoya-shi (JP)

(21) Appl. No.: 12/481,616

(22) Filed: Jun. 10, 2009

(30) Foreign Application Priority Data
Jun. 27, 2008 (JP) 2008-169178

(51) Int. Cl. G03G 9/08

(52) U.S. Cl. 430/137.14

(57) ABSTRACT

The present teachings provide a method for producing a yet superior toner by emulsification aggregation. The method for producing toner by emulsification aggregation comprises the following steps (a) and (b): (a) preparing primary base particles through aggregation and fusion of base microparticles obtained by emulsifying and dispersing a binder resin of the toner; and (b) producing secondary base particles by aggregating the primary base particles with the base microparticles.

### CROSS REFERENCE TO RELATED APPLICATION

The present application claims priority to Japanese Patent Application No. 2008-169178, filed on Jun. 27, 2008, the contents of which are hereby incorporated into the present application by reference.

### BACKGROUND OF THE INVENTION

1. Field of the Invention

The present invention relates to a method for producing toner, and more particularly to a method for producing toner by emulsification aggregation.

2. Description of the Related Art

In electrophotographic or electrostatic recording image forming apparatuses, images can be formed on paper by fixing thereon a toner that is charged with a predetermined polarity and to a predetermined amount of charge. Known such methods for producing toner include emulsification aggregation methods, in which base microparticles of submicron size are aggregated to a desired toner particle size, to form base particles that are then fused by heating to yield toner base particles.

Disclosed such methods involve, for instance, aggregating a suspension, in which base microparticles and a colorant are contained, by using two types of aggregating agent, and followed by fusion (Japanese Patent Application Laid-open Nos. 2000-122344 and 2005-227780). Other methods that have been disclosed involve, for instance, aggregating firstly base microparticles alone, and aggregating next the obtained aggregates with a colorant and the like (Japanese Patent Application Laid-open No. H11-258853).

### SUMMARY OF THE INVENTION

However, not all the base microparticles are aggregated, even when different aggregating agents are used or when the base microparticles are aggregated in two stages. Some of the base microparticles do not aggregate, and end up mixed with the toner in the form of a micropowder. In addition to lowering toner yield, the presence of such unaggregated microparticles also increases fogging during initial printing, whereas in a long-term use, degrading printing quality on account of adhesion of the microparticles onto a developing member.

Therefore, it is an object of the present teachings to provide a method for producing a yet superior toner produced by emulsification aggregation.

After diligent study directed at suppressing the occurrence of unaggregated base microparticles, the inventors found that unaggregated base microparticles, which persist after fusion of aggregates of aggregated base microparticles, can be aggregated with fused base particles. The inventors perfected the present teachings on the basis of that finding. The present teachings provide the means below.

The present teachings provide a method for producing toner by emulsification aggregation, comprising the steps of (a) preparing primary base particles through aggregation and fusion of base microparticles obtained by emulsifying and dispersing a binder resin of the toner; and (b) producing secondary base particles by aggregating the primary base particles with the base microparticles.

### BRIEF DESCRIPTION OF THE DRAWINGS

FIG. 1 illustrates an example of the process flow of the method for producing toner of the present teaching;

FIG. 2 illustrates an example of a streaming potential curve obtained upon addition of a secondary aggregating agent to a base particle suspension;

FIG. 3 illustrates an example of a streaming potential curve obtained upon addition of a secondary aggregating agent to a primary particle suspension;

FIG. 4 illustrates streaming potential curves obtained in a base microparticle suspension for solutions of four types of aggregating agent synthesized in Example 1; and

FIG. 5 illustrates streaming potential curves obtained in a primary base particle suspension for solutions of four types of aggregating agent synthesized in Example 1.

### DESCRIPTION OF THE PREFERRED EMBODIMENTS

The present teachings relate to a method for producing toner. The method for producing toner of the present teachings comprises the steps of (a) preparing primary base particles through aggregation and fusion of base microparticles, and (b) aggregating thereafter unaggregated base microparticles with the primary base particles thereby to produce secondary microparticles. This makes it possible to suppress the occurrence of unaggregated base microparticles and obtain a yet superior toner. In the present teaching, base microparticles are aggregated with primary base particles that are obtainable through aggregation and fusion of base microparticles. This is thought to allow promoting aggregation of the unaggregated base microparticles with the primary base particles while curtailing as a result formation of coarser particles through re-aggregation of primary base particles.

Some of the features in which the aforementioned method may further comprise is described below. In the method for producing toner of the present teachings, preferably, the step (a) comprises aggregating the base microparticles in the presence of a primary aggregating agent, and the step (b) comprises aggregating the primary base particles with the base microparticles in the presence of a secondary aggregating agent. Preferably, the secondary aggregating agent has an inverse polarity to that of the binder resin. Moreover, the secondary aggregating agent has preferably two or more inflection points in a streaming potential curve obtained by, upon addition of the secondary aggregating agent to a suspension of the base microparticles, plotting a streaming potential on the Y-axis and an addition amount on the X-axis.

Preferably, the secondary aggregating agent has a weaker aggregation ability on the base microparticles than the primary aggregating agent. Preferably, the secondary aggregating agent is a polymer having polar groups of the inverse polarity to that of the binder resin. In such an embodiment, the polymer may be obtainable through polymerization of a monomer composition comprising one or two or more monomers selected from among styrenic monomers and acrylic monomers.

In the method for producing toner of the present teachings, the step (b) may be started at a temperature not higher than the glass transition temperature of the primary base particles; and the step (b) may comprise aggregating the primary base particles with the base microparticles remaining in the suspension of the primary base particle, through heating at a temperature near the glass transition point of the primary base particles.

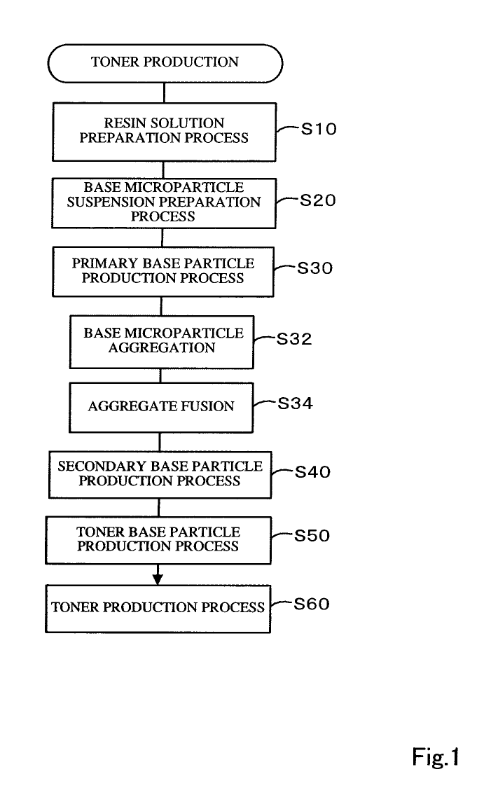

Embodiments of the present teachings are explained in detail below with reference to the accompanying drawings. FIG. 1 is a diagram illustrating an example of the process flow of the method for producing toner of the present teachings. In the description below, the various materials (toner constituent materials) used for producing the toner by emulsification aggregation will be explained first, and the process for producing the toner by emulsification aggregation will be explained next.

In the description of the present teachings, the term “base microparticles” denotes microparticles that result from at least micro-emulsifying, in an aqueous medium, a resin solution comprising a binder resin of the toner. The term “resin solution” denotes a solution comprising at least a binder resin of the toner, and optionally a colorant and a release agent, dissolved or dispersed in an organic solvent. The term “aqueous medium” denotes a medium, comprising mainly water, used during emulsification of the resin solution. The aqueous medium may contain a dispersion stabilizer. The term “primary base particles” denotes base particles obtained by aggregating base microparticles that are in an unaggregated state, which is followed by fusion through heating or the like. The term “secondary base particles” denotes solid particles obtained by aggregation of primary base particles, which are obtained by the aforesaid fusion, with unaggregated base microparticles. Both the “primary base particles” and the “secondary base particles” have sizes approximately of the order of the size of the toner that is to be obtained. The term “toner base particles” denotes particles at a stage preceding the obtaining of the final toner, i.e. secondary base particles or secondary base particles subjected to an appropriate surface treatment. The term “toner” denotes dried toner base particles or toner base particles having optionally an external additive, such as a hydrophobic inorganic dispersant, adhered to the surface of toner base particles.

In the present description, the term “primary aggregating agent” denotes an aggregating agent for aggregating base microparticles in a base microparticle suspension, and the term “secondary aggregating agent” denotes an aggregating agent for aggregating primary base particles with base microparticles.

(Toner Constituent Materials)

The toner obtained in accordance with the production method of the present teachings comprises secondary base particles in which base microparticles are aggregated and adhered to the surface of primary base particles. The primary base particles comprise a binder resin as their main constituent, and comprise optionally, for instance, a colorant, a release agent and a charge control agent. The toner that may be obtained in accordance with the production method of the present teachings may have charge control resin microparticles on the surface of the secondary base particles. Also, the toner obtained in accordance with the production method of the present teachings may have an external additive, such as a hydrophobic inorganic dispersant, adhered to the surface of the toner base particles.

(Binder Resin)

The binder resin, which is the main component of the toner, comprises a synthetic resin that becomes fixed (thermal fusion bonding) onto the surface of a recording medium (paper, an OHP sheet or the like) through heating and/or pressing. The binder resin is not particularly limited, and any known synthetic resin used as a binder resin for toner may be employed. Examples thereof include, for instance, polyester resins, styrene resins (styrene or derivatives thereof such as polystyrene, poly-p-chlorostyrene and polyvinyltoluene; styrene-styrene derivative copolymers such as styrene-p-chlorostyrene copolymers and styrene-vinyltoluene copolymers; and styrene copolymers such as styrene-vinylnaphthalene copolymers, styrene-acrylate copolymers, styrene-methacrylate copolymers, styrene-methyl c-chloromethacrylate copolymers, styrene-acrylonitrile copolymers, styrene-vinyl methyl ether copolymers, styrene-vinyl ethyl ether copolymers, styrene-vinyl methyl ketone copolymers, styrene-butadiene copolymers, styrene-isoprene copolymers, and styrene-acrylonitrile-indene copolymers); and other resins such as acrylic resins, methacrylic resins, polyvinyl chloride resins, phenolic resins, naturally modified phenolic resins, natural resin-modified maleic acid resins, polyvinyl acetate resins, silicone resins, polyurethane resins, polyamide resins, furan resins, epoxy resins, polyvinyl butyral resins, terpene resins, coumarone-indene resins, and petroleum resins. These resins can be used alone or in combination. Preferably, the binder resin has hydrophilic groups. A binder resin having hydrophilic groups allows obviating the need for including a surfactant during emulsion preparation. Examples of hydrophilic groups include, for instance, cationic groups such as quaternary ammonium groups, quaternary ammonium salt-containing groups, amino groups and phosphonium salt-containing groups; and anionic groups such as carboxyl groups and sulfonic acid groups.

The binder resin is preferably a binder resin having anionic groups, more preferably a polyester resin having anionic groups, and in particular, a polyester resin having carboxyl groups (polyester resin having an acid value). The polyester resin used, having carboxyl groups, is a commercially available polyester resin, having for instance an acid value of 0.5 to 40 mgKOH/g, preferably of 1.0 to 20 mgKOH/g, a weight-average molecular weight (as measured by GPC based on a calibration curve using standard polystyrene) of 9,000 to 200,000, preferably 20,000 to 150,000, and having a cross-linked fraction not higher than 10 wt % (THF insoluble fraction), preferably of 0.5 to 10 wt %. A lower acid value than the above ranges entails a smaller amount of reaction with a neutralizer, such as sodium hydroxide, that is added as a dispersion stabilizer. As a result, emulsification may be destabilized and a stable slurry may not be obtained. When, on the other hand, the acid value is higher than the above ranges, the toner is likelier to become excessively charged, which may give rise to problems such as reduced image density. When the weight-average molecular weight is lower than the above range, the mechanical strength of the toner may be insufficient, which can detract from the durability of the toner. By contrast, a weight-average molecular weight higher than the above ranges results in an excessively high melt viscosity in the toner and in large emulsion droplets, whereby coarse particles are likelier to form. Although the cross-linked fraction may be zero, a certain non-zero cross-linked fraction is nonetheless preferable with toner strength and fixabilty (in particular, high-temperature offset) in mind. For instance, the cross-linked fraction (THF insoluble fraction) is preferably no greater than 10 wt %, more preferably of 0.5 to 10 wt %. However, an excessively large cross-linked fraction may give rise to large emulsion droplets and coarse particles.

Polyester resins are superior in that they are transparent, are sufficiently colorless so as not to compromise toner image hue, have good compatibility with the above charge control resin as well as adequate fluidity when heated or under pressure, and can be made into microparticles. Polyester resins are also excellent in terms of charge stability and image quality.

To determine the molecular weight of the resin, the resin component is dissolved in THF to about 0.05 to 0.6 wt %, the insoluble component therein is filtered off with DISMIC (diameter 0.2 μm, made of PTFE, by Advantec). The THF solution fraction is thus collected and is measured in a GPC instrument, to calculate the molecular weight distribution on the basis of a calibration curve using five or more types of monodisperse polystyrene standard samples having a molecular weight of 100 to 10,000,000.

(Colorant)

The colorant, which imparts a desired color to the toner, is incorporated into the binder resin through dispersion or permeation. Carbon black may be used as the colorant. Other examples include, for instance, organic pigments such as Quinophthalone Yellow, Hansa Yellow, Isoindolinone Yellow, Benzidine Yellow, Perynone Orange, Perynone Red, Perylene Maroon, Rhodamine 6G Lake, Quinacridone Red, Rose Bengal, Copper Phthalocyanine Blue, Copper Phthalocyanine Green, or a diketopyrrolopyrole pigment; inorganic pigments and metal powders such as Titanium White, Titanium Yellow, ultramarine, Cobalt Blue, red iron oxide, aluminum powder, and bronze; oil-soluble dyes and dispersion dyes such as azo dyes, quinophthalone dyes, anthraquinone dyes, xanthene dyes, triphenylmethane dyes, phthalocyanine dyes, indophenol dyes, and indoaniline dyes; and rosin dyes such as rosin, rosin-modified phenol, and rosin-modified maleic acid resin. Other examples include dyes and pigments treated with higher fatty acids or resins. The foregoings can be used alone or in combinations corresponding to a desired color. In the case of monochromatic color toner, for instance, the colorant can be prepared by mixing a pigment and a dye of the same color, such as a rhodamine pigment and dye, a quinophthalone pigment and dye, or a phthalocyanine pigment and dye. The colorant is mixed at a ratio of, for example, 2 to 20 parts by weight, preferably 4 to 10 parts by weight, relative to 100 parts by weight of the binder resin.

(Release Agent)

The release agent is added in order to improve the fixability of the toner to the recording medium. In the case of heat and pressure fixing, a wax is ordinarily incorporated into the toner in such a manner that the toner can detach easily from a heating medium. Examples of the release agent include, for instance, ester waxes and hydrocarbon waxes. Examples of ester waxes include, for instance, aliphatic ester compounds, such as stearates, palmitates, as well as polyfunctional ester compounds such as pentaerythritol tetramyristate, pentaerythritol tetrapalmitate and dipentaerythritol hexapalmitate. Examples of hydrocarbon waxes include, for instance, polyolefin waxes such as low-molecular weight polyethylene, low-molecular weight polypropylene and low-molecular weight polybutylene; natural vegetable waxes such as candelilla wax, carnauba wax, rice wax, Japan wax (sumac wax) and Jojoba wax; petroleum waxes such as paraffin, microcrystalline and petrolatum, as well as modified waxes thereof; and synthetic waxes such as Fischer-Tropsch waxes. These waxes can be used alone or in combinations. Preferably, the wax is one of the above waxes having a melting point of 50 to 100° C. A wax having a low melting point and a low melt viscosity melts before melting of the binder resin and becomes smeared on the toner surface, even for a low heating temperature in the fixing device. As a result, offset can be prevented. More specifically, the wax is an ester wax or a paraffin wax. The wax is blended in a proportion of, for instance, 1 to 30 parts by weight, preferably 3 to 15 parts by weight relative to 100 parts by weight of the binder resin.

(Charge Control Agent)

The charge control agent is selected and used from a positively chargeable charge controller and/or a negatively chargeable charge controller, alone or in combination, depending on the intended purpose and the intended application. The charge control agent, which is not particularly limited, is imparted to the toner base particles mainly in one of the following ways, configurations of which may be combined: (1) the charge control agent being added beforehand into the toner base particles and/or (2) the charge control agent being adhered to the surface of the base toner particles.

Examples of the positively chargeable charge control agent used as in above (1) include, for instance, nigrosine dyes, quaternary ammonium compounds, onium compounds, triphenylmethane compounds, compounds containing basic groups, and acrylic resins containing tertiary amino groups. Likewise, examples of the negatively chargeable charge control agents include, for instance, trimethylethane dyes, azo pigments, copper phthalocyanine, salicylic acid metal complexes, benzylic acid metal complexes, perylene, quinacridone and metal-complex azo dyes.

Examples of the charge control agents used as in above (2) include, in addition to the charge control agents used as in (1) also, resin microparticles having a charge control resin as a main component (hereinafter referred to as charge control resin microparticles). In a state where the charge control agent is adhered to the surface of the toner base particles, the way in which adhesion is embodied is not particularly limited, and the charge control agent may be adhered to the surface of the toner base particles by virtue of some interaction, or at least part of the charge control agent may be adhered to the surface by being embedded thereinto, or may be adhered through fusion or the like. When the charge control resin microparticles are caused to adhere to the toner base particles, in a way in which adhesion thereof is embodied may be any of the above, but involves preferably embedding or fusion.

The charge control resin used has preferably polar groups. Using the charge control resin containing polar groups allows obtaining a well-dispersed charge control resin microparticle suspension, and allows the charge control resin microparticles to be fixed homogeneously to the base particles.

In the case with the negative charging toner, preferably a styrene-acrylic copolymer is used. Preferred styrene-acrylic copolymers are not particularly limited, but include, for instance, copolymers of styrene-based monomers such as styrene, o, m, p-chlorostyrene, α-methyl styrene, and alkyl (meth)acrylate monomers selected from alkyl acrylate such as (meth)acrylic acid, maleic acid, itaconic acid, methyl (meth)acrylate, ethyl (meth)acrylate, propyl (meth)acrylate, butyl (meth)acrylate, 2-ethylhexyl (meth)acrylate, amyl (meth)acrylate, cyclohexyl (meth)acrylate, lauryl (meth)acrylate, stearyl (meth)acrylate.

In the case with the positive charging toner, as the polar groups in the charge control resin, quaternary ammonium groups, groups having a quaternary ammonium salt structure, amino groups, and groups having a phosphonium salt structure may be employed. In particular, groups having a salt structure are preferably used. Most preferably, the charge control resin used contains quaternary ammonium (salt) groups. Such groups having a salt structure allow obtaining a stable suspension, even when using no neutralizing agent or surfactants, or when using a limited amount thereof.

Examples of the charge control resin having quaternary ammonium groups include, for instance, a copolymer of a polymerizable component having a quaternary ammonium group, such as methacryloyl oxytrimethyl ammonium sulfate, with another copolymerizable component such as a vinyl-based monomer (cf. Japanese Patent Application Laid-open No. H8-220809) The copolymerizable component is not particularly limited, and any such component may be used so long as it has polymerizable unsaturated bonds. Specific examples thereof include, for instance, styrene, o, m, p-chlorostyrene, α-methyl styrene, vinyl toluene, (meth)acrylic acid, maleic acid, itaconic acid, methyl (meth)acrylate, ethyl (meth)acrylate, propyl (meth)acrylate, butyl (meth)acrylate, 2-ethylhexyl (meth)acrylate, amyl (meth)acrylate, cyclohexyl (meth)acrylate, lauryl (meth)acrylate, stearyl (meth)acrylate, behenyl (meth)acrylate, acrylamide, vinyl chloride, vinyl acetate and the like. Among these vinyl-based monomers at least one monomer selected from among styrene and alkyl (meth)acrylates is preferably used. The akyl (meth)acrylate used has preferably a C1-C18 alkyl group

As the charge control resin, it is preferable that its weight-average molecular weight (Mw) is determined to be within a range of 3,000 to 100,000. When the weight-average molecular weight is lower than 3,000, the toner becomes more likely to be condensed and fused in the course of heat fixing, thereby making the particle size control more difficult. Furthermore in such a case, the mechanical strength of the toner may be insufficient, which may degrade the durability of the toner. To the contrary, a weight-average molecular weight higher than 100,000 results in enlargement of size of particles (i.e. formation of coarse particles) in the course of producing microparticles, and may become difficult to impart sufficient charge thereto. Furthermore in such a case, the possibility of degrading the fixability in low temperature becomes higher.

Preferably, the glass transition temperature (Tg) of the charge control resin is similar to or slightly higher than that of the toner base particles. For instance, when the Tg of the toner base particles is 60° C., the Tg of the charge control resin is set at 60 to 70° C., preferably 60 to 65° C.

The amount of polar groups in the charge control resin can be appropriately adjusted on the basis of the copolymerization conditions. When using for instance a styrene-acrylic copolymer charge control resin, the amount of polar groups can be adjusted by varying the amount of acryl monomers that are copolymerized

The microparticles of the charge control resin being smaller is preferable, for more uniform microparticles can cover the surfaces of the base particles. Therefore, the average particle size of the charge control resin microparticles is preferably sufficiently small relative to the average particle size of the base particles and of a magnitude that does not substantially influence the average particle size of the toner base particles that are obtained through fixing of the charge control resin microparticles. The average particle size of the charge control resin microparticles varies depending on the average particle size of the toner to be obtained, but ranges preferably from about 50 to about 250 nm. The average particle size of the charge control resin microparticles can be determined by dynamic light scattering (laser Doppler), using a particle size analyzer Nanotrac™ UPA150 (manufactured by Nikkiso Co. LTD.). Specifically, the method set forth in the below examples may be utilized.

(External Additive)

Examples of the external additive include inorganic particles and synthetic resin particles. Examples of the inorganic particles that can be used include, for instance, silica, aluminum oxide, titanium oxide, silicon aluminum cooxide, silicon titanium cooxide, and hydrophobicized products thereof. Hydrophobization of a silica micropowder may involve, for instance, treating the silica micropowder with silicon oil or a silane coupling agent such as dichlorodimethylsilane, hexamethyldisilazane, tetramethyldisilazane or the like. Examples of synthetic resin particles include, for instance, methacrylate polymer particles, acrylate polymer particles, styrene-methacrylate copolymer particles, styrene-acrylate copolymer particles, and core-shell particles in which a shell of a methacrylate polymer is formed on a core of a styrene polymer. The addition amount of external additive is not particularly limited, and ranges ordinarily from 0.1 to 6 parts by weight relative to 100 parts by weight of the toner comprising the toner base particles.

(Method for Producing Toner)

The method for producing toner of the present teaching will be explained next. The method for producing toner of the present teaching is an emulsification aggregation method, comprising in particular the following steps (a) and (b): (a) preparing a primary base particle suspension containing primary base particles that are obtained through aggregation and fusion of base microparticles resulting from emulsifying and dispersing a binder resin of the toner; and (b) preparing a secondary base particle suspension containing secondary base particles that are obtainable by aggregating the primary base particles with the base microparticles. The base microparticles may remain in the primary base particle suspension. The method for producing toner by emulsification aggregation of toner, comprising the above steps, will be explained below with reference to accompanying drawings. FIG. 1 is a diagram illustrating an example of the process flow of the method for producing toner of the present teachings.

In typical emulsification aggregation, toner is ultimately obtained after a series of processes that include a resin solution preparation process S10; a base microparticle suspension preparation process S20; a primary base particle production process S30; and a secondary base particle production process S40; followed by a toner base particle production process S50 and a toner production process S60 (FIG. 1).

(Resin Solution Preparation Process: Step S10)

As illustrated in FIG. 1, the resin solution preparation process S10 may comprise firstly dissolving or dispersing the binder resin, plus ordinarily a colorant and, optionally, a release agent, in an organic solvent. Preferably, the binder resin dissolves in a solvent. When using a pigment as the colorant, the pigment is micro-dispersed, since it does not dissolve. Although the release agent is preferably dissolved as well, it need not necessarily be dissolved, and may be micro-dispersed instead. In the preparation of the resin solution, the resin solution may be appropriately heated at a temperature not higher than the boiling point of the organic solvent. Such heating is particularly preferred when a release agent is dissolved or dispersed.

Preferably, the organic solvent dissolves a wax at a temperature below the boiling point, but it is also desirable that the organic solvent should exhibit some water solubility in order to promote emulsification of the binder resin. In the production method of the present invention, it is particularly preferred to reduce the use of dispersants such as surfactants or the like for stabilizing an emulsion of the resin solution. It becomes then necessary to neutralize the hydrophilic groups of the binder resin. When using as a result a wholly hydrophobic solvent, the neutralization reaction does not advance, and emulsion stabilization becomes harder to accomplish. The solvent therefore has some water solubility. Preferably, such an organic solvent can exhibit a compatibility of 1 to 100% with respect to water at 25° C. Specific examples of the organic solvent include, for instance, esters such as ethyl acetate and butyl acetate; glycols such as ethylene glycol, diethylene glycol, ethylene glycol monomethyl ether and diethylene glycol monomethyl ether; ketones such as acetone, methyl ethyl ketone (MEK) and methyl isobutyl ketone; and ethers such as tetrahydrofuran (THF). These organic solvents can be used alone or in combination. Preferably, the organic solvent has a boiling point of 50 to 100° C., more preferably of 60 to 90° C. A specific example thereof is methyl ethyl ketone (boiling point: 79. 6° C. at normal pressure (1 atm)) or tetrahydrofuran (boiling point: 65° C. at normal pressure). The organic solvent is blended in a proportion of, for instance, 100 to 2,000 parts by weight, preferably 200 to 1,000 parts by weight relative to 100 parts by weight of binder resin.

In the preparation of the resin solution, a colorant dispersion is preferably prepared beforehand by micro-dispersing the colorant in a solvent. The method for dispersing the colorant may involve, for instance, mixing the colorant, a solvent and a dispersant, and pre-dispersing the mixture in a disper, a homogenizer or the like, followed by micro-dispersion in a bead mill, a high-pressure homogenizer or the like. In order to prevent colorant aggregation when preparing beforehand a colorant dispersion, the colorant dispersion is preferably diluted slowly first, and is then mixed with the resin and/or release agent to dissolve/disperse the foregoing during the preparation of the resin solution.

When using a dye or the like that dissolves in the solvent, the colorant need not particularly be dispersed. A dispersant for pigment dispersion is preferably used in order to micro-disperse the pigment. For instance, a surfactant or a high-molecular weight dispersant can be used as the dispersant. A binder resin may also function as a dispersant, and hence the binder resin may also be used as the dispersant.

(Base Microparticle Suspension Preparation Process: Step S20)

The base microparticle suspension preparation process S20 may comprise preparing an emulsion by mixing and emulsifing the resin solution and the aqueous medium, then removing organic solvent component from the emulsion, and thereby preparing a suspension in which the base microparticles are dispersed in the aqueous medium.

The aqueous medium may be water, or a liquid mixture of water and an organic solvent compatible with water. Examples of the organic solvent include, for instance, an alcohol. Examples of additives that may be comprised in the aqueous medium include, for instance, surfactants, dispersants and the like. In the production method of the present invention, the aqueous medium is preferably prepared as an aqueous alkaline solution. Examples of the aqueous alkaline solution include an aqueous organic base solution prepared by dissolving a basic organic compound such as an amine in water, and an aqueous inorganic base solution prepared by dissolving an alkaline metal such as sodium hydroxide or potassium hydroxide in water. The aqueous inorganic base solution is prepared as an aqueous sodium hydroxide solution or aqueous potassium hydroxide solution of, for example, 0.1 to 5N (normal), preferably 0.2 to 2N (normal). If a wax poorly dissolvable in the resin solution is blended therein on account of water inclusion, then an aqueous organic base solution is preferably employed, in terms of preventing precipitation of the wax.

Emulsification can be carried out down to a much smaller toner particle size, of the order of 100 to 500 nm, due to the shearing imparted thereupon with a homogenizer or the like. Stabilizing the emulsion in this state and then removing the solvent allows to obtain a suspension having the base microparticles at the nm level dispersed therein. A dispersant is preferably used for emulsification. The dispersant, however, affects greatly the charge performance of the toner, and hence a dispersant capable of eliciting emulsion stabilization when added in as small an amount as possible may be selected.

In the production method of the present teaching, emulsion stabilization is preferably accomplished without using the dispersant, but instead, a neutralizer (aqueous solution of an alkali such as sodium hydroxide) for neutralizing the acid groups (carboxyl groups and the like) in the binder resin is preferably used to impart hydrophilicity to the binder resin itself. A specific example of the neutralizer is sodium hydroxide. Emulsion stabilization is carried out by mixing the neutralizer with the aqueous medium or with the resin solution, or by adding the neutralizer after mixing the resin solution with the aqueous medium.

The solvent can be removed once the emulsion is stabilized. To remove the organic solvent from the emulsion, a conventionally known method such as air-blowing, heating, vacuum, or a combination thereof may be employed. For instance, the emulsion is heated in an inert gas atmosphere, from room temperature to 90° C., preferably from 65 to 80° C., until about 80 to 95wt % of the initial amount of the organic solvent is removed. As a result, the organic solvent is removed from the aqueous medium, thereby to prepare a suspension (slurry) in which resin microparticles of the binder resin having the colorant and wax uniformly dispersed thereon is dispersed in an aqueous medium. For instance, the volume average particle size of the resin microparticles of the base microparticles ranges preferably from about 50 nm to about 1000 nm. The volume average particle size smaller than 50 nm tends to require a greater amount of aggregating agent during aggregation. The volume average particle size in excess of 1000 nm makes it more difficult to achieve toner base particles having a sharp particle size distribution during aggregation. Within these ranges, moreover it becomes easier to destabilize a dispersion of base microparticles while stabilizing a dispersion of primary base particles, in a below-described secondary base particle production process.

The average particle size of the base microparticles can be determined by dynamic light scattering (laser Doppler), using a particle size analyzer Nanotrac™ UPA150 (Nikkiso Co. LTD.). The specific method used may be the method set forth in the examples.

Emulsification may be carried out by blending the resin solution into the aqueous medium or by blending the aqueous medium into the resin solution. A polyester resin is used in the present teaching, and hence neutralization can be carried out by blending beforehand an alkaline aqueous solution and an amine-based solvent into a resin solution, and blending then water into the resin solution. Also, water may be blended into a resin solution neutralized beforehand.

(Primary Base Particle Production Process: Step S30)

The primary base particle production process S30 may comprise a step of aggregating base microparticles (S32) and a step of fusing aggregates of the base microparticles to yield primary base particles (S34).

(Aggregating Base Microparticles: Step S32)

In the step of aggregating base microparticles S32, the base microparticles obtained in the above process S20 are aggregated to yield aggregates of base microparticles. Firstly, the solids concentration in the suspension is adjusted by diluting with water the base microparticle suspension, as the case may require. An aggregating agent for emulsification aggregation may be added to the suspension. The aggregating agent used for aggregating base microparticles in a base microparticle suspension is referred to in the present description as the primary aggregating agent. Examples of the primary aggregating agent include, for instance, inorganic metal salts such as calcium nitrate and magnesium chloride, polymers of inorganic metal salts such as polyaluminum chloride, and cationic surfactants. In the present teachings, an inorganic metal salt or a polymer thereof is preferably used, since these aggregating agents, typified by strongly acidic metal salts (preferably, salts of a strong acid and a weak base), have a strong base microparticle aggregation ability. In other words, such aggregating agents have a strong tendency to aggregate the above-described binder resins such as polyester resins, eliciting thus strong base microparticle aggregation ability. For instance, the primary aggregating agent can aggregate base microparticles in an addition amount smaller than that of the below-described secondary aggregating agent.

In the base microparticle aggregation step S32 a dispersion enhancer may be used. Examples of dispersion enhancers include, for instance, known dispersion enhancers such as aqueous solutions of alkalis like sodium hydroxide. Examples of nonionic surfactants used as dispersion enhancers include, for instance, polyoxyethylene polyoxypropylene glycol, polyoxyalkylene decyl ether, polyoxyalkylene tridecyl ether, polyoxyethylene isodecyl ether, polyoxyalkylene lauryl ether, polyoxyethylene alkyl ether and the like, preferably polyoxyethylene polyoxypropylene glycol.

During aggregation step S32, an aqueous solution of the aggregating agent adjusted for instance to 0.01 to 1.0N (normal), preferably 0.05 to 0.5N (normal), is added, with stirring, at a ratio of for instance 0.1 to 10 parts by weight, preferably 0.5 to 5 parts by weight relative to 100 parts by weight of the suspension. The stirring method is not particularly limited. For instance, the suspension is dispersed in a high-speed dispersing apparatus such as a homogenizer, after which mixing proceeds using a stirrer equipped with stirring blades, to completely fluidize the suspension thereby. As the mixing blade, a well-known blade such as a flat turbine blade, a propeller blade or an anchor blade is used. Stirring may also be carried out using an ultrasonic disperser. The liquid temperature during stirring is, for instance, 10 to 50° C., preferably 20 to 30° C., and the stirring time is for instance 5 to 60 minutes, preferably 10 to 30 minutes. Thereafter, the suspension is preferably heated, to homogenize the aggregated state. Heating is carried out for instance up to a temperature at which particles do not fuse. In terms of preventing formation of coarse particles, heating is carried out preferably at a liquid temperature lower than the Tg of the base microparticles. For instance, the suspension is heated at a temperature of 35 to 60° C., more preferably temperature of about 40 to about 45° C.

Once the base microparticles have formed aggregates of desired size, an aggregation terminator is preferably added to discontinue aggregation. The volume average particle size of the primary base particles ranges for instance not less than about 6 μm to not more than about 10 μm. As the aggregation terminator, an ionic surfactant having an inverse polarity to that of the aggregating agent, or, for instance, an alkaline metal such as sodium hydroxide or potassium hydroxide may be used. During aggregation discontinuation, an alkaline metal aqueous solution adjusted for instance to 0.01 to 5.0 N (normal), preferably 0.1 to 2.0 N (normal), is added at a ratio of for instance 0.5 to 20 parts by weight, preferably 1.0 to 10 parts by weight, relative to 100 parts by weight of the suspension, under continued stirring. For instance, an aqueous solution of sodium hydroxide is added as the aggregation terminator. The size of the primary base particles can be measured in accordance with the Coulter method using, for instance, a Coulter Multisizer II (Beckman Coulter, Inc.). The method set forth in the examples may be employed as the specific measurement method

(Aggregate Fusion: Step S34)

In the aggregate fusion S34, primary base particles are prepared by fusing aggregates through heating. In aggregate fusion S34, the suspension is heated at a temperature not lower than the glass transition temperature (Tg) of the binder resin, under continued stirring. For instance, the suspension is heated at 55 to 100° C., preferably at 65 to 95° C. For instance, the suspension is heated up to a liquid temperature of 90° C. Preferably, the suspension is heated to a temperature 20° C. or more higher, preferably a temperature 30° C. or more higher than the Tg of the binder resin.

The aggregates undergo shape changes when fusing, and hence heating is discontinued once the desired shape is achieved. The suspension is then cooled, under continued stirring, down to a temperature not higher than the Tg of the binder resin. Cooling may involve natural cooling or rapid cooling by way of external cooling water or the like. Fused aggregates, namely primary base particles, can be thus obtained as a result. In actuality, a suspension containing primary base particles can be obtained.

In the production method of the present teachings, obtaining the primary base particles through aggregation and fusion of base microparticles allows effectively carrying out the subsequent supplementary aggregation process (e.g. the secondary base particle production process S40). The highly uneven surface shape of the aggregates comprising independent base microparticles can be smoothed out (i.e. made homogeneous), and hence the surface area of the aggregates can be reduced, by thermally melting the aggregates, which causes the base microparticles comprised in the aggregates to fuse. This allows, suppressing the secondary aggregation of primary base particles in the supplementary aggregation process, and promoting aggregation of unaggregated base microparticles onto primary base particles. As a result, through the addition of a small amount of aggregating agent, it is also possible to selectively aggregate primary base particles with base microparticles.

The suspension containing primary base particles thus obtained may then be subjected to solid-liquid separation and washing, as the case may require, to adjust solids concentration, aqueous content and the like to suitable levels. The unaggregated base microparticles may remain in suspension together with the primary base particles. Alternatively, at least part of the unaggregated base microparticles may be removed from the suspension that contains the primary base particles.

(Secondary Base Particle Production Process: Step S40)

The secondary base particle production process (S40) is a process in which secondary base particles are obtained by causing the base microparticles to aggregate and adhere onto the primary base particles obtained through aggregation and fusion of the base microparticles. In the secondary base particle production process of the method for producing toner of the present teachings, relatively abundant primary base particles, having an evened-out surface and a large particle size with base microparticles that are present in relatively small amounts, are aggregated. It should be noted that in the present embodiment, the primary base particles have already been fused. Therefore, it effectively allows the primary base particles to not to be secondarily aggregated with each other, and allows the base microparticles to promote its aggregation onto the primary base particles. As a result, a state in which dispersion and aggregation readily and simultaneously taking place can be achieved.

In the process S40, the secondary base particles are obtained through aggregation of base microparticles onto the primary base particles. The base microparticles used in the present process S40 may be those originally contained in the base microparticle suspension, and which have remained, in the primary base particle suspension used in the present process S40, as unaggregated base microparticles that have failed to form aggregates in the earlier primary base particle production process S30. In this case, the primary base particle suspension ultimately obtained in the primary base particle production process S30 can be used, without modification, in the secondary base particle production process S40. Doing so is preferable, since in that case the primary base particle production process S30 and the secondary base particle production process S40 can easily be carried out consecutively.

The base microparticles used in the present process S40 are not limited to base microparticles obtained in the primary base particle production process S30 and remaining in the primary base particle suspension that is used in the present process S40. The base microparticles may be unaggregated base microparticles having been removed already from the primary base particle suspension, and which are added again to the primary base particle suspension when the present process S40 is carried out. Also, the base microparticles used in the present processes S40 may be surplus base microparticles or base microparticles formed in another process of the toner production. The base microparticles may also be prepared separately.

In the present processes S40, the secondary aggregating agent is preferably added to a primary base particle suspension, containing primary base particles and base microparticles, and adjusted to suitable solids concentration and the like. Ordinarily, aggregation and fusion of the primary base particles and the base microparticles is carried out in a liquid medium, so that after aggregation and fusion the secondary base particles are obtained in suspension. The secondary aggregating agent can have two or more of characteristics (1) to (3) below.

Preferably, the secondary aggregating agent is an aggregating agent having a polarity (i.e. charge) inverse to that of the primary base particles (feature (1)). Using such an inverse-polarity aggregating agent allows imparting the surface of the primary base particles with an inverse polarity (may it be one of negative and positive) that is the reverse of the original polarity (may it be the other of positive and negative), and allows enhancing dispersion stability. Aggregation between primary base particles can be suppressed as a result. As regards the interplay between primary base particles and base microparticles, using such an inverse-polarity aggregating agent allows promoting aggregation of base microparticles onto the surface of primary base particles by neutralizing the polarity (may it be positive or negative) of the surface of the primary base particles.

The aggregating agent having an inverse polarity to that of the primary base particles is herein, for instance, a cationic aggregating agent (having cationic functional groups), when the primary base particles are anionic (having anionic functional groups such as carboxylic groups). The polarity of the primary base particles depends mainly, for instance, on the polarity of the binder resin.

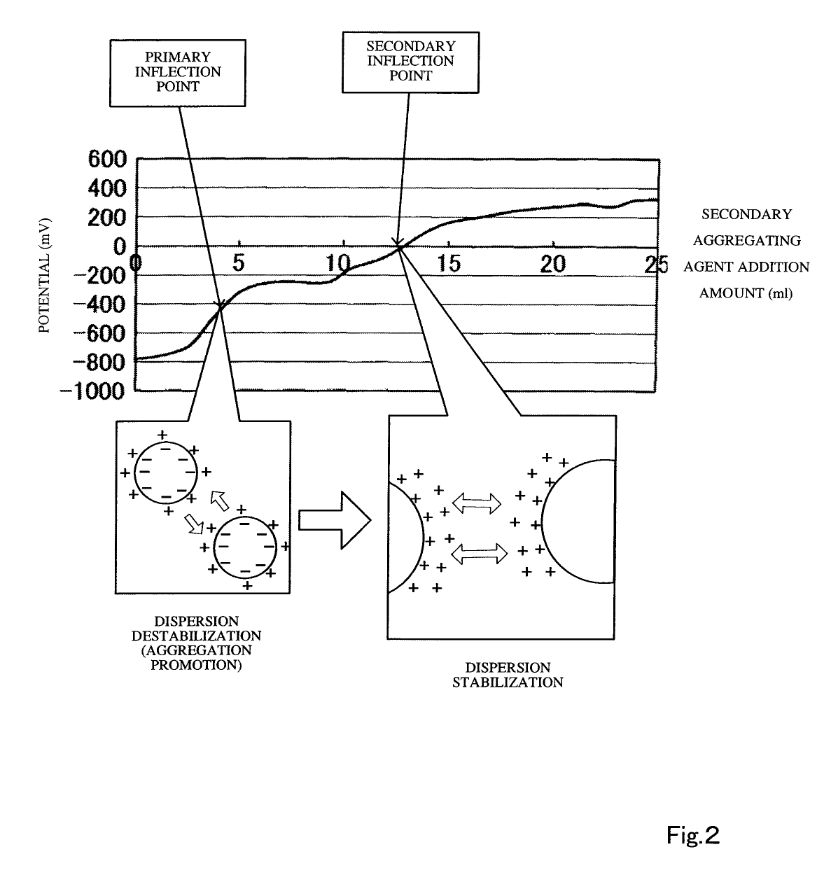

Preferably, the secondary aggregating agent has two or more inflection points in a streaming potential curve (curve resulting from plotting streaming potential on the Y-axis and addition amount on the X-axis) that is obtained as the aggregating agent is added to the base microparticle suspension (feature 2)). Preferably, the aggregating agent has two inflection points. FIG. 2 illustrates an example of a streaming potential curve corresponding to addition of such a secondary aggregating agent to a base microparticle suspension. FIG. 2 depicts an example of a secondary aggregating agent having two inflection points.

When the secondary aggregating agent is added to the suspension that was in a dispersion stable state, the charge on the surface of the base microparticles is thought to become neutralized in the vicinity of a primary inflection point, as illustrated in FIG. 2. It is estimated herein that addition of the secondary aggregating agent reduces the electrostatic repulsion between base microparticles, facilitating aggregation of the latter. It is also estimated that in the vicinity of a secondary inflection point, the supplementarily added secondary aggregating agent becomes adhered, in the form of a double layer, onto the surface of aggregates and the like that become aggregated when the base microparticles are neutralized in the vicinity of the primary inflection point. Dispersion stability of the particles increases then on account of electrostatic repulsion.

In a situation where the primary base particles and the base microparticles are intermixed, an aggregating agent that brings out such streaming potential changes is very effective in stabilizing the dispersion of primary base particles and in promoting aggregation of base microparticles, through addition of a small amount of aggregating agent. This is thought to result in suppression of aggregation between primary base particles, and in promotion of aggregation of base microparticles onto the primary base particles. The effect of the secondary aggregating agent on the base microparticles and the primary base particles is enhanced; thanks to the reduced surface area of the coexisting primary base particles, which have been fused already.

Preferably, the aggregation ability of the secondary aggregating agent on the base microparticles is weaker than that of the primary aggregating agent (feature (3)). The strength of the aggregation ability can be evaluated on the basis of the amount of aggregating agent that is required for bringing the streaming potential to about 0 V (or at least to a potential saturation state for a definite addition amount range) in the streaming potential curve that is obtained as the aggregating agent is added to the base microparticle suspension. For instance, when two aggregating agents are added to a base microparticle suspension, the aggregating agent that is required in a greater addition amount for bringing the streaming potential to about 0 V, or for achieving a potential saturation state in the potential curve, can be considered as the aggregating agent having the weaker aggregation ability. Aggregating agents that elicit such gentle changes in streaming potential are thought to contribute to aggregation between base microparticles and primary base particles by moderately promoting aggregation through a decrease in the dispersion stability of the base microparticles. The effect of the secondary aggregating agent on the base microparticles is enhanced by the fact that the primary base particles, coexisting with the base microparticles, are already fused.

Among the above features (1) to (3), the secondary aggregating agent has preferably the feature (1). In addition to the feature (1), the secondary aggregating agent has preferably also the feature (2) and/or (3).

Except for a case in which the secondary aggregating agent has the feature (3), the primary aggregating agent may be identical to or different from the secondary aggregating agent; however, the aggregating agents being different is preferable, given that the aggregating agent used as the primary aggregating agent, which needs not exhibit the above feature (3), is preferably an aggregating agent that is more effective in aggregating the base microparticles. It should be noted that this does not preclude using the same aggregating agent as the primary aggregating agent and the secondary aggregating agent since, depending for instance on the aggregation aids or dispersants used, there are cases in which a predetermined goal can be attained, in the production process of the primary base particles and/or the secondary base particles, even when the primary base particles and the secondary base particles are the same.

The streaming potential curve can be measured in accordance with known methods. For instance, the streaming potential curve can be measured using an automatic potentiometric titrator AT-5 10 (Kyoto Electronics Manufacturing).

Although not particularly limited thereto, various aggregating agents having the inverse polarity (charge) to that of the binder resin can be used as such a secondary aggregating agent. Preferably, however, the secondary aggregating agent is an organic aggregating agent, and more preferably an organic polymeric aggregating agent. Yet more preferably, the secondary aggregating agent is a polymeric aggregating agent having functional groups of inverse polarity to that of the binder resin. When the binder resin has hydrophilic groups, for instance cationic groups such as quaternary ammonium groups, quaternary ammonium salt-containing groups, amino groups or phosphonium salt-containing groups, the secondary aggregating agent may have, as the functional groups of inverse polarity to the foregoing, for instance anionic groups such as carboxyl groups or sulfonic acid groups. Conversely, when the binder resin has hydrophilic groups, for instance anionic groups such as carboxyl groups or sulfonic acid groups, the secondary aggregating agent may have, as the functional groups of inverse polarity to the foregoing, for instance cationic groups such as quaternary ammonium groups, quaternary ammonium salt-containing groups, amino groups or phosphonium salt-containing groups.

Examples of the polymer that constitute the secondary aggregating agent include, for instance, polymers obtained through polymerization of a monomer composition of one or two or more monomers selected from among styrenic monomers and acrylic monomers. Polymers having such monomer compositions boast great design flexibility, in terms of, for instance, control of the polarity of the secondary aggregating agent, control of the intensity of that polarity, and solubility control. In addition, polymers having such monomer compositions polymerize readily.

Such a secondary aggregating agent can be synthesized in accordance with ordinary polymer synthesis methods, or can be sourced commercially.

The secondary base particle production process S40 is carried out by adding to the suspension an effective amount of an aqueous solution of secondary aggregating agent that is adjusted to an appropriate concentration, while stirring. Such stirring is not particularly limited. The suspension may be dispersed, as the case may require, in a high-speed dispersing apparatus such as a homogenizer, after which mixing proceeds using a stirrer equipped with stirring blades, to completely fluidize the suspension thereby. As the mixing blade, a well-known blade such as a flat turbine blade, a propeller blade or an anchor blade is used. Stirring may also be carried out using an ultrasonic disperser.

The addition amount of the secondary aggregating agent is not particularly limited, so long as it allows promoting aggregation of the primary base particles with the base microparticles while reducing the amount of unaggregated base microparticles. The effective addition amount (the effective amount) of the secondary aggregating agent can be arbitrarily decided taking into account the type of secondary aggregating agent (for instance, the ratio of inverse-polarity functional groups), solution characteristics such as the pH of the primary base particle suspension, the streaming potential curve obtained through addition of the secondary aggregating agent to the base microparticle suspension, and the liquid temperature upon aggregation initiation in the secondary base particle production process S40. The effective addition amount of the secondary aggregating agent can also be set after determining beforehand the relationship between the addition amount and the amount of residual base microparticles.

An instance in which the preferred addition amount of secondary aggregating agent is determined on the basis of the streaming potential curve of a base microparticle suspension using that secondary aggregating agent can be explained with reference to FIG. 2. In the secondary base particle production process, an addition amount of secondary aggregating agent used is preferably equivalent to an addition amount such that the tendency of the base microparticles to aggregate, on account of the secondary aggregating agent, which is brought from a high state (in the vicinity of the initial inflection point (primary inflection point)) to a situation before a state in which the aggregated base microparticles tend to repel (in the vicinity of the next inflection point (secondary inflection point)), in the streaming potential curve obtained upon addition of the secondary aggregating agent to the base microparticle suspension. That is, the addition amount is equivalent to the addition amount of secondary aggregating agent from the primary inflection point to before the secondary inflection point in the streaming potential curve. Within such a range, dispersion stability of the base microparticles is weakened while dispersion stability of the particles (primary base particles), resulting from aggregating and fusing the base microparticles, is enhanced. That is, a state is achieved in which the base microparticles and the primary base particles coexist in conflicting dispersion states with respect to each other. As a result, the aggregation between primary base particles is suppressed while the aggregation of base microparticles with primary base particles is promoted, and thus formation of coarse particles through aggregation between primary base particles can be curtailed while allowing the amount of unaggregated base microparticles (micro-powder) to be reduced.

Although the causes for the above phenomenon are not necessarily clear, that does not impose any theoretical constraints on the present teachings. However, this phenomenon is thought to arise from differences in surface area per unit volume between the base microparticles and the primary base particles, whereby the aggregating agent forms a double layer on the surface of the primary base particles, as a result of which the primary base particles are brought to a dispersion stable state (state in which electrostatic repulsion between particles is ensured). By contrast, the aggregating agent forms regions of weakened dispersion stability (state in which electrostatic repulsion between particles is weakened) on the base microparticles.

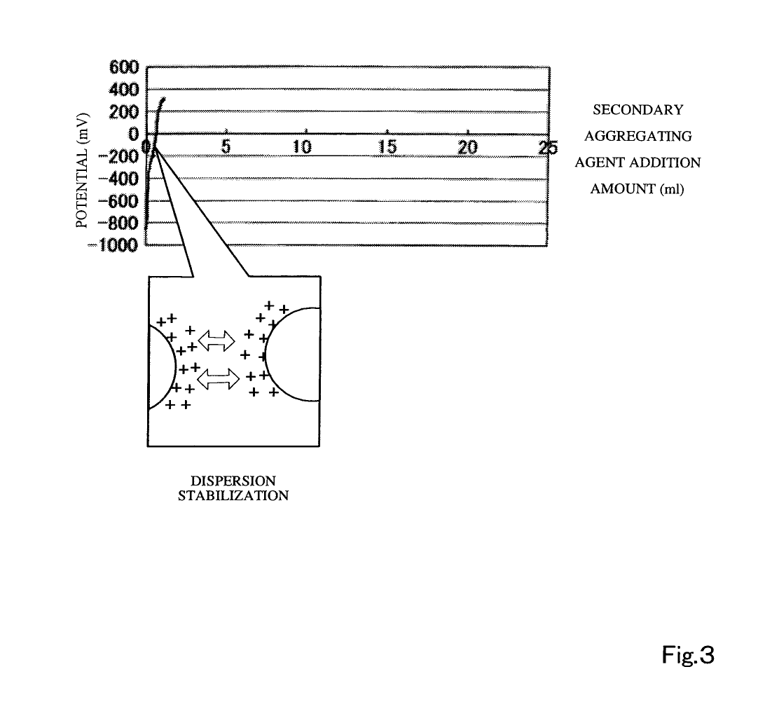

FIG. 3 illustrates an example of a streaming potential curve corresponding to addition of an appropriate amount of secondary aggregating agent to a primary base particle suspension during the secondary base particle production process. When an appropriate amount of secondary aggregating agent is added to the primary base particle suspension, the primary base particles, having already been imparted large particle size and a smooth surface through aggregation, are brought to a stabilized dispersion state, as illustrated in FIG. 3, even if the secondary aggregating agent is added in an amount that lowers the dispersion stability of the base microparticles. Although not shown in the streaming potential curve of FIG. 3, the secondary aggregating agent, in an appropriate amount, is believed to act at the same time in such a manner so as to destabilize the dispersion state of the remaining base microparticles, thereby promoting aggregation of the latter with the dispersed primary base particles.

The addition amount of secondary aggregating agent can be arbitrarily adjusted so as to lie within a range of equivalent addition amount of secondary aggregating agent that extends from the primary inflection point to before the secondary inflection point, in the streaming potential curve. In consideration of temperature during aggregation, stirring and the like, however, the addition amount of secondary aggregating agent is preferably equivalent to an addition amount of secondary aggregating agent ranging from the primary inflection point to before the secondary inflection point, with a view to reliably reducing the amount of unaggregated base microparticles. More preferably, the addition amount of the secondary aggregating agent is equivalent to an addition amount of the secondary aggregating agent ranging from the primary inflection point to halfway between the primary inflection point and the secondary inflection point. The addition amount of the secondary aggregating agent can be calculated on the basis of the addition amount (weight) of the secondary aggregating agent used relative to the amount of (weight) of base microparticles, in a streaming potential curve plotted beforehand. The addition amount of secondary aggregating agent is then set, relative to the total weight of base microparticles present in the form of base microparticles and primary base particles comprised in the primary base particle suspension, to an amount equivalent to the amount calculated above.

The liquid temperature upon aggregation initiation in the secondary base particle production process S40 is preferably not higher than the glass transition temperature (Tg) of the primary base particles. When the liquid temperature at the start of aggregation exceeds the Tg of the primary base particles, particles show a strong tendency to aggregate with each other. As a result, aggregation takes place only in the vicinity of the sites where the secondary aggregating agent is added, and the secondary aggregating agent fails to spread throughout. This causes the base microparticles to persist and the primary base particles to aggregate each other to form coarse particles, which is at variance from the situation originally intended. A liquid temperature not higher than the Tg of the primary base particles makes this phenomenon easier to suppress. More preferably, the starting temperature is lower than the Tg of the primary base particles by no less than 10° C., more preferably by no less than 20° C. Although not particularly limited thereto, the starting temperature may be a temperature that allows the primary base particle suspension to be stirred without freezing. The Tg of the primary base particles varies depending on the Tg of the binder resin that makes up the primary base particles and on the materials of the primary base particles (for instance, plasticizers or components having a plasticizing effect). The Tg of the primary base particles may be brought below the Tg of the binder resin.

As the addition amount of secondary aggregating agent increases, the liquid temperature upon aggregation start is preferably set to be lower than the above-described ranges. When the addition amount is small, the liquid temperature is preferably set to be higher than the above-described ranges, since a high liquid temperature tends to facilitate aggregation, whereas a low liquid temperature tends to make aggregation harder to occur. For instance, the liquid temperature during aggregation initiation may be raised, with a view to eliciting an aggregating effect, upon reduction of the amount of secondary aggregating agent used.

After aggregation initiation, preferably, heating is carried out up to a temperature close to the Tg of the primary base particles. Such heating allows re-fusing the aggregates of primary base particles and base microparticles, and allows homogenizing the aggregation state. Preferably, the heating temperature is not higher than, for instance, the Tg of the primary base particles plus about 10° C. Also, the heating temperature is preferably not lower than the Tg of the primary base particles minus about 10° C., more preferably not lower than Tg minus 5° C. The heating temperature is preferably kept near the Tg for a given time, for instance from about 20 minutes to about 1 hour.

Thereafter, heating is discontinued, and the suspension is cooled down to a temperature not higher than the Tg of the primary base particles, preferably a temperature lower than the Tg of the primary base particles by no less than 10° C., and more preferably a temperature lower than the Tg of the primary base particles by no less than 20° C., under continued stirring. Cooling may involve natural cooling or rapid cooling by way of external cooling water or the like. The fused aggregates, namely the secondary base particles, can be obtained accordingly. That is, a suspension containing secondary base particles can be obtained. In the suspension from which the secondary base particles are obtained, the base microparticles are aggregated onto and fused with the primary base particles, and hence the amount of unaggregated base microparticles therein decreases.

(Toner Base Particle Production Process: Step S50)

The charge characteristics of the secondary base particles may be adjusted, as the case may require, by way of a charge control agent, charge control resin microparticles or the like. A process for imparting charge characteristics to the surface of the secondary base particles will be explained next.

(Imparting of Charge Characteristics to the Secondary Base Particles)

Charge characteristics can be imparted to the secondary base particles by way of a charge control agent or by way of charge control resin microparticles. An explanation follows next on a process for causing charge control resin microparticles to adhere to the secondary base particles. Charge characteristics can be imparted effectively, using a small amount of charge control agent, by applying and fixing charge control resin microparticles to the surface of the secondary base particles. Furthermore, the process can be made more uniform and more robust, as compared with dry methods, by carrying out adhesion and fixing onto the secondary base particles within a liquid. Specifically, the charge control resin microparticles are caused to adhere to the surface of the secondary base particles by mixing the secondary base particles with a charge control resin microparticle suspension. The preparation of the charge control resin microparticle suspension used in the present process will be explained first, and the manufacture of the toner base particles will be explained next. The explanation below deals in particular with an example in which microparticles of a styrene-acrylic copolymer containing quaternary ammonium salt groups, as positive charge control resin microparticles, are caused to adhere to the secondary base particles. This example may be part of a positive charging toner production process.

(Production of Charge Control Resin Microparticle Suspension)

Firstly, the charge control resin is mixed with water and an organic solvent capable of dissolving or swelling the charge control resin, and the resulting mixture is emulsified in a high-speed stirrer such as a homogenizer. A suspension in which the charge control resin microparticles are dispersed in the aqueous medium can be obtained by removing the organic solvent component from the emulsion using a known method such as heating under reduced pressure. The size of the charge control resin microparticles can be controlled by adjusting the ratio between resin, solvent and water and by adjusting shear forces in the stirrer. The size of the charge control resin microparticles can also be controlled on the basis of, for instance, the molecular weight of the resin. The average particle size of the charge control resin microparticles can range, for instance, from 50 nm to 250 nm. The average particle size of the charge control resin microparticles can be determined by laser scattering using a Microtrac particle size analyzer Nanotrac™ NPA150 (UPA150, by Nikkiso Co. LTD.). The charge control resin can be produced by using solution polymerization, emulsion polymerization, soap-free emulsion polymerization or the like.

(Mixing of the Base Particle Suspension and the Charge Control Resin Microparticle Suspension)

Predetermined amounts of the base particle suspension and the charge control resin microparticle suspension are mixed together, and are stirred or the like in such a manner that the base particles and the charge control resin microparticles come into good contact with each other. Thereafter, the resulting mixture is heated under predetermined conditions, thereby to produce toner base particles upon which the charge control resin microparticles are fixed to the surfaces thereof. Preferably, the charge control resin microparticles are embedded to a certain extent into the toner surface. To that end, the charge control resin microparticles are preferably fixed at a liquid temperature around the Tg of the base particles. For instance, if the Tg of the base particles is 55° C., then the charge control resin microparticles are preferably mixed and then heated and stirred at a temperature of 55° C. for 15 to 60 minutes.

In the base particle production step as explained above, the toner base particles, comprising charge control resin microparticles on the surfaces of the secondary base particles, are obtained in the form of a suspension comprising the particles.

(Toner Production Process: Step S60)

The toner base particles thus obtained as a result of the above operations are sufficiently charged themselves. However, it is preferable to cause an external additive to adhere to the surfaces of the toner base particles, with a view to enhancing fluidity and storage stability in the toner. Preferably in particular, an inorganic oxide hydrophobized using a silane coupling agent or the like is externally added. After addition of the external additive, the toner base particles may be sorted with a sieve or the like to yield the final toner.

Upon adhesion of the external additive, the toner base particles are preferably recovered, for instance, by filtering the toner base particle suspension obtained in the toner base particle production process S40, and then washing and drying the toner base particles to a predetermined water content. Washing is carried out by replacing at least part of the toner base particle suspension with a low-conductivity medium such as water. This can be accomplished, specifically, by performing solid-liquid separation on the toner base particle suspension and by re-suspending solid content in water or the like, for an appropriate number of times. For instance, drying is performed preferably down to a water content not higher than 1 wt %. The drying method is not particularly limited, and ordinary methods may be employed. Drying may be accomplished, for instance, by fluidized bed drying or air stream drying (Flash Jet Dryer, by Seishin Enterprise).

The above-described method for producing toner of the present teachings comprises a primary base particle production process S30 and a secondary base particle production process S40. The amount of unaggregated base microparticles can be reduced as a result, which allows toner to be obtained with good yield. The method for producing toner of the present teachings, moreover, affords a more workable toner in which initial fogging can be suppressed or avoided, and in which there can be suppressed or avoided long-term use problems (for instance, impairment of print quality on account of lessened resolution or the like) that occur when microparticles become fixed to developing members.

Though in the above description a case of producing positively charged toner has been exemplified, negative charging toner can be obtained likewise by using charge control resin microparticles with negative charge. In a case where the surface of the base particles are processed with a charge control agent, the dispersed aqueous medium of the charge control agent or solution thereof may be mixed with the base particles, stirred, heated if required, and then filtered and dried, thereby to fix the charge control agent to the toner base particles. The dispersed solution of the charge control agent is adjusted to be an aqueous solution, for instance, to be 5 to 20 wt % of charge control agent. The dispersed solution of the charge control agent is added at a ratio of for instance 0.1 to 10 parts by weight, preferably 0.5 to 5 parts by weight relative to 100 parts by weight of the suspension. As a result, the charge control agent is fixed to the secondary base particles of 100 parts by weight at a rate of 0.01 to 5 parts by weight, preferably 0.05 to 3 parts by weight.

The toner obtained in accordance with the production method of the present teachings can be preferably used as a non-magnetic mono-component toner (i.e. single component developer), but can also be used as a two-component toner, for instance by being blended with a suitable carrier. As the carrier there can be used glass beads, steel shot or the like coated with a resin, in the case of cascade developing, or ferrite, iron dust or so-called binder-type carriers in the case of magnetic brush developing.

The toner obtained in accordance with the production of the present teachings can be used as toner in electrophotographic and electrostatic-recording image forming apparatuses such as all manner of monochrome/color laser printers, fax machines, copiers and multifunction machines.

The present teachings will be explained in more detail next on the basis of specific examples. The teachings disclosed herein, however, are not limited to or by the examples below. In the examples, “parts” denote “parts by weight” and “%” denotes weight percent.

### EXAMPLE 1

(Synthesis of a Cationic Polymer-Based Aggregating Agent)

In the present example, a cationic polymer-based aggregating agent as the secondary aggregating agent used for producing the secondary base particles of the present teachings were synthesized.

(Preparation of Styrene Monomers)

Firstly, distilled water (500 g) and sodium hydroxide (solid: 2 g) were charged into a 1 L beaker, where the sodium hydroxide was dissolved under stirring. Styrene monomers (500 ml) were added then to the beaker, with stirring for 5 minutes. The beaker was then left to stand to let the styrene phase and the aqueous phase separate, and the styrene phase was recovered. This operation was repeated twice on the recovered styrene phase.

(Monomer Polymerization)

Besides the styrene monomers prepared as described above, an acrylate monomer, N,N-dimethylaminopropylacrylamide methyl chloride quaternary salt (DMAPAA-Q), which is an acrylic monomer having a polarity inverse to that of the primary base particles (toner binder resin) produced in Example 2 described below, 2,2-azobis(2,4-dimethylvaleronitrile) V65 (polymerization initiator), MEK and methanol were mixed and dissolved in a 1 L beaker, on the basis of the monomer solution compositions given in the Table below, to prepare four monomer solutions.

TABLE 1

| | | | Aggregating | Aggregating | Aggregating | Aggregating |
|---|---|---|---|---|---|---|
| | | | agent A | agent B | agent C | agent D |
| Styrene monomers | | Kanto | 59.4 | 58.5 | 57 | 51 |
| (grade 1) | | Chemical | | | | |
| Butyl acrylate | | Kanto | 237.6 | 234 | 228 | 203.9 |
| | | Chemical | | | | |
| Acrylic monomer | (*1) | Kohjin | 3 | 7.5 | 15 | 45.1 |
| Initiator | (*2) | Wako | 5 | 5 | 5 | 5 |
| | | Pure | | | | |
| | | Chemical | | | | |
| MEK (grade 1) | | Kanto | 50 | 50 | 50 | 50 |
| | | Chemical | | | | |
| Methanol | | Kanto | 150 | 150 | 150 | 150 |
| (special grade) | | Chemical | | | | |

(*1) N,N-dimethylaminopropylacrylamide methyl chloride quaternary salt (DMAPAA-Q)
(*2) 2,2-azobis(2,4-dimethylvaleronitrile) V65

Next, each of the above four monomer solutions was added to a polymerization apparatus (round-bottom separable flask, inner diameter about 125 mm, capacity 1 L) provided with a reflow apparatus, with nitrogen bubbling for 30 minutes, through blowing of 50 ml/min of nitrogen gas into the polymerization apparatus. Next, the end of a nitrogen feeding opening was raised into the gas phase portion, and the flow rate of nitrogen was changed to 30 ml/minute. The polymerization apparatus was immersed in a bath heated to 65° C., where the monomer solution was left to react for 10 hours under stirring at 120 rpm using a stirring blade (crescent-type stirring blade, width: 100 mm). After 10 hours, the obtained resin viscous liquid (constituents: resin, residual monomers, MEK and methanol) was transferred to a 500 ml beaker. The beaker was placed on a hot plate heated to 135° C., and the volatile fraction was removed under stirring using a spatula.

The synthesized compounds were spread thin while the viscosity thereof was low on account of the residual heat. The compounds were left to stand for 6 hours in an environment having a degree of vacuum of 700 mmHg or more. The compounds were air-dried thereafter over several days, to yield water-soluble cationic polymers. The solids concentration of the obtained cationic polymers was measured, and the polymers were dissolved, through addition of distilled water, to 20% net solids, to prepare a total of four cationic polymer-based aggregating agent solutions.

### EXAMPLE 2

In the present example toners were produced, under the various conditions given in Table 2, using the aggregating agent solutions prepared in Example 1. The obtained toners were evaluated for particle size distribution, supernatant solids, as well as print characteristics during initial printing and long-term printing. Toner production examples, methods for evaluating the toner, and the results of the evaluations are explained below.

(Production of Primary Base Particles)

(1) Preparation of a Base Microparticle Suspension

Firstly, a container provided with a reflux apparatus was charged with 160 parts of a polyester resin FC1565 (Mn3,800, Mw56,000, THF insoluble fraction 2 wt %, acid value 4.4 mgKOH/g, Tg 61.9° C.; by Mitsubishi Rayon), 8 parts of carbon black #260 (Mitsubishi Chemical), 8 parts of pentaerythritol Unistar H476 (NOF Corporation) as a release agent, and 640 parts of methyl ethyl ketone (Kanto Chemical, grade 1). The container holding the above materials was heated to 60° C. The resin and the wax were dissolved in the methyl ethyl ketone, and the carbon black was dispersed, under stirring and reflux, to prepare thereby a first solution. In a separate container, 800 parts of distilled water and 8 parts of a 1N aqueous solution of sodium hydroxide were mixed. The mixture was heated to 60° C., while preventing evaporation using a watch glass, to prepare a second solution. Next, 800 parts of the first solution and 800 parts of the second solution, both heated to 60° C., were mixed in a 2 L beaker, and the resulting mixture was stirred for 30 minutes at 16,000 rpm using a homogenizer DIAX 900 (Heidolph Japan). The beaker was placed in a water bath set to 60° C., and the methyl ethyl ketone was removed through evaporation, under gentle stirring, until the measured methyl ethyl ketone was at or below the detection limit, to produce a base microparticle suspension. This dispersion was cooled to room temperature. The measured solids concentration of the dispersion was 23.1%. The average particle size of the solid microparticles was 0.275 μm, as measured using a Nanotrac™ UPA150 (Nikkiso). The measurement was carried out as follows. A dilute liquid is prepared by adding three to four drops of the base microparticle dispersion to 50 ml of distilled water. The measurement unit of the above analyzer is filled with distilled water, and is set to blank (set zero). Thereafter, the diluted liquid of the base microparticle dispersion is added, using a dropper, in an amount suitable for display on the monitor screen. Measurement is initiated next. The measurement settings are as follows:

Solvent: water, refractive index 1.333, viscosity 0.797(30° C.), 1.002(20° C.)

Particles: transparent, refractive index 1.91, true spherical shape, density 1.25

Device: SetZero 60 seconds, measurement time 120 seconds, three measurements, standard filter, standard sensitivity.

(2) Aggregation of the Base Microparticles

Next, the base microparticle suspension was diluted with distilled water to adjust the solids concentration to 20wt %, after which 800 g of the diluted suspension were sampled and transferred to a 3 L round separable flask, to which 740 g of distilled water and 60 g of a 5% aqueous solution of a surfactant Noigen XL70 (Dai-Ichi Kogyo Seiyaku) were added. Then, 30 g of a 0.2N aluminum chloride aqueous solution were added as a primary aggregating agent. The whole was stirred in a homogenizer DIAX 900 at 8,000 rpm, while the beaker was being moved, to cause the aluminum chloride to spread throughout the suspension. After a lapse of 5 minutes, 6 g of a 0.2N sodium hydroxide aqueous solution were added, with continued stirring for further 5 minutes. The separable flask was placed in a water bath at 45° C., was covered with a separable cover having two or more openings, and was stirred for 30 minutes, using six flat turbine blades having a diameter of 7 cm and a height of 2 cm, setting the revolutions so as to yield a tip speed of about 1.3 m/sec. The stirring blades were raised to a position at a height of 2 cm from the bottom of the flask. After 30 minutes had elapsed, a 0.2N sodium hydroxide aqueous solution was added to stop aggregate growth. Thereupon, the revolutions of the stirring blades were slowed down to a tip speed of about 1.1 m/sec, with stirring for 10 minutes. After 10 minutes, the revolutions of the stirring blades were slowed direction to a tip speed of about 0.75 m/sec, and the temperature of the suspension was raised to 95° C. at a temperature rise rate of 1° C./min. Upon reaching 95° C., the temperature was held there, and stirring continued for a further 100 minutes. After the 100 minutes, part of the suspension was sampled. The sample was inspected using an optical microscope to verify that sub-micron aggregated particles had melted and adhered, on account of heating, into spherical shapes.

Under further continued stirring, the suspension was cooled to a temperature not higher than the Tg of the aggregated particles (about 30° C.), to yield a suspension containing primary base particles. After cooling, the particle size of the primary base particles was measured using a Coulter Multisizer II (aperture diameter of 100 μm, by Beckman Coulter). The results revealed a number average particle size Dn of 6.77 μm, a volume average particle size Dv of 7.91 μm, a proportion of particles having a size of 5 μm or less of 11.84 number percent and a proportion of 0.43vol % having a particle size of 20 μm or larger. The solids fraction (microparticles) dispersed in the supernatant of the primary base particle suspension was 1.75%.

(Production of Secondary Base Particles)

Herein, 1000 ml of the obtained suspension were added to a 2 L separable flask, which was covered with a separable cover having two or more openings. The tip speed of six flat turbine blades having a diameter of 7 cm and a height of 2 cm was set to about 0.45 m/sec. The various aggregating agent solutions synthesized in Example 1, having an inverse polarity to that of the produced primary base particles, were added under stirring to the cooled primary base particle suspension (1,000 ml) in the addition amounts given in Table 2. Table 2 gives the liquid temperatures of the primary base particle suspension and the secondary aggregating agent solutions at the time of addition of the secondary aggregating agent solutions. Under continued stirring, the resulting suspension was heated for 30 minutes at the glass transition temperature (54° C.) of the primary base particles. After the 30 minutes, part of the suspension was sampled to measure the particle size distribution. The suspension was then cooled under continued stirring, to 30° C., below the Tg of the primary base particles, to yield a secondary base particle suspension.

The secondary base particle suspension was vacuum-filtered using filter paper No. 5B (by Advantec), followed by further filtering using 1500 g of distilled water with which the resulting cake was rinsed. Vacuum filtering was carried out to a water content of about 20%. The filter cake was removed to separate the secondary base particles.

(Production of Toner Base Particles)

Charge characteristics were imparted next to the secondary base particles, using a charge control agent, following the procedures below.

(Preparation of a Charge Control Agent Solution)

A plastic centrifuge tube (500 ml) was filled with 54 g and 306 g of methanol, which were mixed in the tube. A charge control agent (CCA) (Bontron N 21, alkylbenzene sulfonate-modified azine, lot M003279, by Orient Chemical) was added to this container, which was stirred for two days, using a magnetic stirrer, until achieving fluidity throughout the liquid. The stirred liquid was left to stand for 48 hours, and was then centrifuged at 10,000 rpm for 30 minutes, to separate the coarse product through sedimentation. The measured solids concentration of this CCA solution was 0.84%.

(Addition of Charge Control Agent onto the Secondary Base Particles)

Two 4L separable flasks were prepared. To each flask 1,600 g of the CCA solution prepared earlier and 100 g of the secondary base particle filter cake (water content about 20%) were added. Ultrasounds (28 kHz, 650 W) were then applied for 1 minute under stirring using a spatula. The separable flasks were then immersed in a water bath set to 25° C., and were stirred for 30 minutes at 140 rpm using a turbine of six flat blades (diameter 70 mm, height 2 cm). Further, 1,100 g of distilled water were dropped onto each separable flask at a rate of about one drop per second (average 20 to 35 g/min). Once dropping was over, ultrasounds were applied for 1 minute under stirring, whereafter the flasks were left to stand for 30 minutes.

(Toner Production)

The suspension comprising toner base particles having a charge control agent added thereto were vacuum-filtered using a filter paper No. 5B (Advantec). The filter cake was removed and was dried to a water content of 1 wt % or less in a drier at 50° C. Next, 150 parts of the dried toner base particles, 1.5 parts of hydrophobic silica microparticles (HVK2150, Clariant) and 2.5 parts of alumina (WA#4000, Fujimi Incorporated) were added to a Mechanomill (Okada Seiko), with mixing and stirring for 3 minutes at 28,000 rpm, to yield the toners of Examples 1 to 12. These toners were evaluated for various characteristics in accordance with the below-described evaluation methods. The results are summarized in Table 2.

(Supernatant Solids Concentration)

About 1 g of sample to be tested (supernatant of the secondary base particle suspension) was sampled and weighed on an aluminum plate of known weight. The aluminum plate, having the test sample thereon, was placed in a thermostatic bath at 50° C. for 24 hours or more to evaporate the volatile fraction. The weight of the solid product remaining on the aluminum plate was divided by the weight of sample, to determine the solids concentration.

(Measurement of the Particle Size Distribution of the Secondary Base Particles and the Toner)

Particle size distribution was measured using a Coulter Multisizer II (Beckman Coulter) as the measurement instrument under the measurement conditions below. In the measurement, for instance, an appropriate amount of test sample (for example, 0.2 g) were mixed with 50 cc of distilled water with several drops of dispersant (type-1C: Beckman Coulter), with ultrasonic dispersion or the like, as the case may require, to prepare a suspension. A sample of the suspension was fed into the measurement instrument, in an amount suitable for display on the monitor. About 50,000 particles were measured. The 50% particle size in the volume-basis particle size distribution was taken as the volume average size.

Aperture diameter: 100 μm

Aperture current: 1,600 μA

Channels: 256

Kd value: 937.75

Gain: 2

Polarity: negative

(Streaming Potential of the Aggregating Agent (Inflection Point))

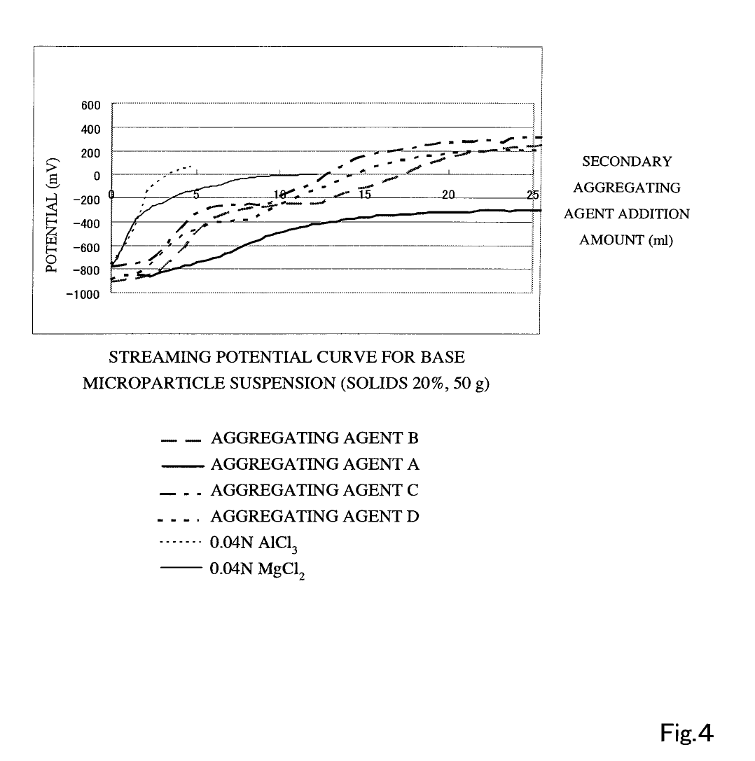

The streaming potential curves for the base microparticle suspensions of the four aggregating agent solutions produced in Example 1, as well as the inflection points of the curves, were measured in accordance with the procedure below. The streaming potential curves of 0.04N aluminum chloride and 0.04N magnesium chloride were measured in the same way. The inflection points were detected automatically. FIG. 4 illustrates the titration curves (streaming potential curves) up to a dripped volume of 25 ml of aggregating agent solution.

(1) A sample of each of the base microparticle suspensions (solids 20%) manufactured in Example 1 is collected, in an amount of 50 ml, and is placed in a 100 ml tall beaker. (Liquid temperature 25±2° C.)

(2) A magnetic stirrer is put in the beaker, and then ⅓ or more of the electrode of an automatic potentiometric titrator AT-510 (Kyoto Electronics Manufacturing) is dipped into the sample solution.

(3) The electrode is operated under stirring with a magnetic stirrer, adjusting the operation speed of the electrode in such a manner that the absolute value of the streaming potential ranges from 600 mV to 1000 mV (in this case, the numerical value of the stirrer adjusting knob is set to 70 and the numerical value of the potential adjusting knob is set to 590).

(4) The aggregating agent solutions adjusted to a concentration of 20% are dripped at a rate of 4 ml/min.

(5) Titration is terminated when the potential becomes positive with the plot approaching saturation.

If the sample solution spills over the beaker as titration progresses, the entire sample is moved to a larger beaker, where the measurement is resumed. In such cases it must be ensured that ⅓ or more of the electrode is immersed in the sample solution.

(Printing Evaluation)

The printing evaluation of the toner involved filling 100 g of the produced toner into a laser printer (HL-2040: Brother Kogyo K.K.), and measuring initial transmission density and fogging. To accelerate the occurrence of problems in the long-term printing test, the latter was carried out under the following conditions.

Number of print sheets: 2000 sheets

Print paper: 4200 201b (Xerox)

Print pattern: characters having a size of 3 to 4 mm distributed over the entire paper surface. The sum of portions developed by toner was equivalent to 4% of the paper surface area, taking the paper surface area for printing as 100%.

Sheet running interval: upon output of each print product, the driving system of the printer stood by for about 1 second before starting the next printing operation.

Printing environment: temperature 32.5° C., humidity 80%.

(Fogging (Whiteness Difference))

Whiteness difference, as a fogging index, is determined in accordance with the following procedure using a photometer TC-6MC-D (Tokyo Denshoku). A lower numerical value of fogging (whiteness difference) entails better printing.

(1) No-printing data are sent to the printing device (HL-2040), prompting the device to perform white printing.

(2) Halfway during white printing, the cover of the device is opened and the drive thereof is forcibly stopped.

(3) The developing unit is removed and the developer is dismantled.

(4) Mending tape, by Scotch, is affixed to the portions after development and before transfer on the photosensitive member (namely the nip (contact) portion between the photosensitive member and the developing roller, and the portion between the nip of the photosensitive member and the transfer roller, to account for slip after forced stop), to collect on the tape the fogging toner that forms on the photosensitive member.

(5) The tape is detached carefully from the photosensitive member, and is affixed to Xerox 4200 paper, to yield fogging sample 1.

(6) The whiteness of three arbitrary points on the obtained fogging sample 1 are measured using the above-described photometer. The average value of the three points yields whiteness 1.

(7) Meanwhile, a clean mending tape, having no fogging sample collected thereon, is affixed to the same paper, to yield fogging sample 2.

(8) The whiteness of fogging sample 2 is measured in the same way as for fogging sample 1, to yield whiteness 2.

(9) The value resulting from subtracting whiteness 2 from whiteness I is the “whiteness difference” index of fogging.

(Transmission Density)

Transmission density was measured in accordance with the procedure below using a densitometer TD-904 (Macbeth).

(1) Data (hereinafter, solid pattern) for 100% printing over about 20 mm square is sent to the printing device (HL-2040). The device prints this solid pattern in the vicinity of the four corners of the print paper.

(2) The transmission density of each solid pattern is measured at five points (four corners and center). The average value of the data for the total 20 points is taken as the transmission density for that sample.

### COMPARATIVE EXAMPLES

Toners of Comparative examples 1 to 4 were manufactured in the same way as the toners of samples 1 to 12, but using now the suspension (suspension of base microparticle aggregates) before fusion, instead of the primary base particle suspensions produced in the example, for the solutions of the various aggregating agents A to D produced in Example 1, under the conditions given in Table 3. As Table 3 shows, the toners of Comparative examples 5 and 6 were produced in the same way as the toners of samples 1 to 12, but using 0.2N aluminum chloride and 0.2N magnesium chloride as the secondary aggregating agent, under the conditions given in Table 3. The toners of Comparative examples 1 to 6 were evaluated in the same way as the toners of samples 1 to 12. The results are summarized in Table 3.

TABLE 2

| Secondary aggregating | | Secondary aggregating | | Aggregation | | |
|---|---|---|---|---|---|---|
| agent | | agent addition conditions | | conditions | Volume | |
| | Inflection | Amount | Temperature | Temperature | average | 5 μm↓ |
| Type | point (g)*1 | (g) | (° C.) | (° C.) | μm | Number % |

| | | | | | | | |
|---|---|---|---|---|---|---|---|
| Control | None | / | / | / | / | 7.91 | 11.84 |
| Sample 1 | Aggregating | 7.2 | 24 | 35 | 55 | 7.85 | 8.60 |
| Sample 2 | agent A | 7.2 | 100 | 30 | 55 | 7.90 | 5.40 |
| Sample 3 | | 7.2 | 200 | 25 | 55 | 8.01 | 3.50 |
| Sample 4 | Aggregating | 4.7 | 13 | 35 | 55 | 7.98 | 7.40 |
| Sample 5 | agent B | 4.7 | 55 | 30 | 55 | 8.20 | 4.80 |
| Sample 6 | | 4.7 | 95 | 27 | 55 | 7.86 | 2.80 |
| Sample 7 | Aggregating | 3.6 | 14 | 35 | 55 | 8.09 | 6.80 |
| Sample 8 | agent C | 3.6 | 45 | 30 | 55 | 8.23 | 4.10 |
| Sample 9 | | 3.6 | 73 | 26 | 55 | 7.99 | 2.10 |
| Sample 10 | Aggregating | 3.2 | 10 | 35 | 55 | 8.32 | 7.20 |
| Sample 11 | agent D | 3.2 | 45 | 30 | 55 | 7.95 | 3.80 |
| Sample 12 | | 3.2 | 74 | 27 | 55 | 8.30 | 1.60 |

| | | Supernatant | Initial | | 2000 sheet durability | |
|---|---|---|---|---|---|---|
| | 20 μm↑ | solids | Whiteness | Transmission | Whiteness | Transmission |
| | Vol % | wt % | difference | density | difference | density |
| Control | 0.43 | 1.75 | 1.76 | 1.75 | 2.86 | 2.05 |
| Sample 1 | 0.40 | 1.32 | 0.81 | 1.82 | 0.54 | 2.01 |
| Sample 2 | 0.45 | 0.76 | 0.75 | 1.80 | 0.61 | 2.16 |
| Sample 3 | 0.41 | 0.50 | 0.72 | 1.79 | 0.37 | 2.15 |
| Sample 4 | 0.42 | 1.07 | 0.54 | 1.83 | 0.54 | 2.09 |
| Sample 5 | 0.50 | 0.70 | 0.83 | 1.80 | 0.91 | 2.04 |
| Sample 6 | 0.43 | 0.40 | 0.46 | 1.82 | 0.34 | 2.21 |
| Sample 7 | 0.42 | 0.98 | 0.92 | 1.81 | 0.49 | 2.09 |
| Sample 8 | 0.40 | 0.65 | 0.44 | 1.79 | 0.67 | 2.13 |
| Sample 9 | 0.46 | 0.64 | 0.72 | 1.84 | 0.76 | 2.18 |
| Sample 10 | 0.44 | 0.94 | 0.51 | 1.78 | 0.91 | 2.07 |
| Sample 11 | 0.41 | 0.56 | 0.83 | 1.83 | 0.55 | 2.09 |
| Sample 12 | 0.28 | 0.64 | 1.83 | 0.16 | 2.14 | |

*1primary inflection point for 50 ml of 20% solids slurry. (Example conditions involved 10 times the addition amount for yielding 1000 ml of 10% slurry.)

TABLE 3

| | | | Secondary aggregating | | Aggregation | | |
|---|---|---|---|---|---|---|---|
| | Aggregating agent | | agent addition conditions | | conditions | Volume | |
| | | Inflection | Amount | Temperature | Temperature | average | 5 μm↓ |
| | Type | point (g)*1 | (g) | (° C.) | (° C.) | μm | Number % |
| Comp. | Aggregating | 7.2 | 450 | 27 | 55 | 7.92 | 10.89 |
| example 1 | agent A | | | | | | |
| Comp. | Aggregating | 4.7 | 150 | 25 | 55 | 7.86 | 11.28 |
| example 2 | agent B | | | | | | |
| Comp. | Aggregating | 3.6 | 100 | 27 | 55 | 7.55 | 12.35 |
| example 3 | agent C | | | | | | |
| Comp. | Aggregating | 3.2 | 120 | 26 | 55 | 7.95 | 11.15 |
| example 4 | agent D | | | | | | |
| Comp. | 0.2N AlCl₃ | 0.7 | 7 | 26 | 55 | 12.50 | 0.79 |
| example 5 | | | | | | | |
| Comp. | 0.2N MgCl₂ | 0.7 | 3 | 26 | 55 | 10.64 | 0.86 |
| example 6 | | | | | | | |

| | | Supernatant | Initial | | 2000 sheet durability | |
|---|---|---|---|---|---|---|
| | 20 μm↑ | solids | Whiteness | Transmission | Whiteness | Transmission |
| | Vol % | wt % | difference | density | difference | density |
| Comp. | 0.43 | 1.68 | 1.54 | 1.72 | 2.24 | 2.11 |
| example 1 | | | | | | |
| Comp. | 0.40 | 1.79 | 1.68 | 1.71 | 2.56 | 2.12 |
| example 2 | | | | | | |
| Comp. | 0.40 | 1.81 | 1.55 | 1.79 | 2.31 | 2.11 |
| example 3 | | | | | | |
| Comp. | 0.42 | 1.66 | 1.79 | 1.77 | 2.71 | 2.08 |
| example 4 | | | | | | |
| Comp. | 18.33 | 0.09 | / | / | / | / |
| example 5 | | | | | | |
| Comp. | 16.97 | 0.15 | / | / | / | / |
| example 6 | | | | | | |

*1primary inflection point for 50 ml of 20% solids slurry. (Example conditions involved 10 times the addition amount for yielding 1000 ml of 10% slurry.)

As Table 2 shows, all the toners of samples 1 to 12, obtained by way of the secondary base particles produced using the aggregating agents A to D synthesized in Example 1, exhibited a particle size distribution having a reduced number percent, no greater than 5 μm, and exhibited decreased supernatant solids. That is, all the aggregating agents can be used for producing secondary base particles by causing unaggregated base microparticles to aggregate and become fixed onto primary base particles, over a wide range of addition amount of the aggregating agents. Specifically, the particle size distribution and supernatant solids of the toners of samples 1 to 12 exhibit a substantial improvement vis-à-vis a control example, in which no secondary aggregation process is carried out. In particular, yet better results are achieved by adding greater amounts of the aggregating agents A to D.

Upon addition to the base microparticle suspension, the aggregating agents A to D exhibit two inflection points (primary inflection point and secondary inflection point) in the streaming potential curve, as explained below. In terms of the primary inflection point and the secondary inflection point of the aggregating agents, the amount of secondary aggregating agent added in samples 1 to 12 lies within a range corresponding to a range that extends from a little less than an equivalent amount of the primary inflection point up to before the secondary inflection point. Supernatant solids, initial fogging, long-term fogging and so forth were better in samples 2, 3, 5, 6, 8 and 9, in which the aggregating agents were added in a range of amounts corresponding to a range extending from the vicinity of the secondary inflection point to an intermediate point between the primary inflection point and the secondary inflection point.

As the printing evaluation reveals, these toners exhibited also good results both for initial printing and long-term printing. The results showed also that, in particular, fogging during long-term printing was better suppressed as the supernatant solids decreased through addition of a greater amount of secondary aggregating agent.

By contrast, the results of Comparative examples 1 to 4 in Table 3 show that formation of unaggregated base microparticles could not be suppressed even through the action of the secondary aggregating agents on the base microparticles and the base microparticle aggregates before fusion. In Comparative examples 1 to 4, re-aggregation could not be achieved even using the secondary aggregating agents in substantial amounts. From the above it follows that forming primary base particles by fusing base microparticles is effective for re-aggregation.

The above results showed also that when the secondary aggregating agents synthesized in Example 1 are not used, i.e. when a secondary aggregating agent having an inverse polarity to that of the binder resin is not used, as is the case in Comparative examples 5 and 6, it is difficult to elicit aggregation between the primary base particles and the base microparticles under the same conditions as when a secondary aggregating agent is used. This indicates that using a secondary aggregating agent having an inverse polarity to that of the binder resin is advantageous for producing easily secondary base particles through aggregation of base microparticles onto primary base particles.

As illustrated in FIG. 4, all four aggregating agents A to D synthesized in Example 1 exhibited streaming potential curves having two inflection points. The first inflection point for the aggregating agent solutions of samples I to 4 stood at 7.2 ml, 4.7 ml, 3.6 ml and 3.2 ml. The second inflection point stood at 60.1 ml, 18.1 ml, 12.7 ml and 13.1 ml (see Table 4). The streaming potential curves of the four aggregating agents A to D differ greatly from the streaming potential curves of aluminum chloride and magnesium chloride. The above results reveal that an aggregating agent having a streaming potential curve such as the one afforded by the four aggregating agents A to D synthesized in Example 1 can be preferably used for re-aggregating the primary base particles with the base microparticles.

TABLE 4
Inflection points in streaming potential curve for a base
microparticle suspension (solids 20%, 50 g)

| | | Secondary |
|---|---|---|
| Type of secondary | Primary inflection | inflection |
| aggregating agent | point ml | point ml |
| A | 7.2 | 60.1 |
| B | 4.7 | 18.1 |
| C | 3.6 | 12.7 |
| D | 3.2 | 13.1 |

### EXAMPLE 3

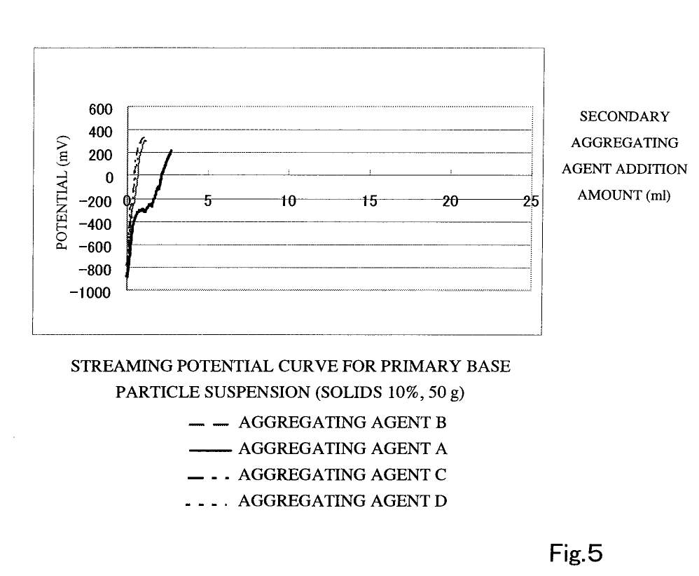

In the present example the streaming potential curves obtained upon dripping the four aggregating agents A to D synthesized in Example 1 onto the primary base particle suspension (about 10% solids) (50 g) obtained in Example 2 was measured. The measurement method was identical to that of Example 2. The results are illustrated in FIG. 5. Also, Table 5 gives the primary inflection point and the secondary inflection point, obtained on the basis of the streaming potential curve, for the primary base particle suspension.

TABLE 5
Inflection points in streaming potential curve for a primary
base particle suspension (solids 10%, 50 g)

| Type of secondary | Primary | Secondary |
|---|---|---|
| aggregating agent | inflection point | inflection point |
| A | 0.24 | 2.15 |
| B | 0.18 | 0.65 |
| C | 0.16 | 0.49 |
| D | 0.12 | 0.49 |

When the aggregating agents A to D are added to the primary base particle suspension, the streaming potential rises at an addition amount of the secondary aggregating agent at which the latter causes the dispersion stability of the base microparticles to fall, as illustrated in FIG. 5. Dispersion stabilization can be thus achieved, without causing the primary base particles to aggregate with each other. The above results and the results of Example 2 indicate that the dispersion of primary base particles is stabilized, and aggregation between primary base particles and base microparticles is promoted, by adding the aggregating agents A to D synthesized in Example 1 to the primary base particle suspension, depending on the type of the aggregating agent.

As Table 5 shows, the aggregating agents A to D exhibited two inflection points also in the streaming potential curves for the primary base particle suspension. The results indicate that primary base particles are dispersion-stabilized when the addition amount of the secondary aggregating lies in a range within which the secondary aggregating agent causes the dispersion stability of the base microparticles to decrease.

What is claimed is:

1. A method for producing toner by emulsification aggregation, comprising the steps of:
(a) preparing primary base particles through aggregation and fusion of base microparticles that may be obtained by emulsifying and dispersing a binder resin of the toner; and
(b) producing secondary base particles by aggregating the primary base particles with the base microparticles.

2. The method for producing toner according to claim 1,
wherein the step (a) comprises aggregating the base microparticles in the presence of a primary aggregating agent, and
the step (b) comprises aggregating the primary base particles with the base microparticles in the presence of a secondary aggregating agent.

3. The method for producing toner according to claim 2, wherein the secondary aggregating agent has an inverse polarity to that of the binder resin.

4. The method for producing toner according to claim 3, wherein
the secondary aggregating agent has two or more inflection points in a streaming potential curve obtained by plotting a streaming potential on the Y-axis and an addition amount on the X-axis, wherein the addition amount is an amount of the secondary aggregating agent that is added to a suspension of the base microparticles.

5. The method for producing toner according to claim 2, wherein the secondary aggregating agent has a weaker aggregation ability on the base microparticles than the primary aggregating agent.

6. The method for producing toner according to claim 2, wherein the secondary aggregating agent is a polymer having polar groups of an inverse polarity to that of the binder resin.

7. The method for producing toner according to claim 6, wherein the polymer is obtained through polymerization of a monomer composition comprising one or two or more monomers selected from among styrenic monomers and acrylic monomers.

8. The method for producing toner according to claim 1, wherein the step (b) is started at a temperature not higher than the glass transition temperature of the primary base particles.

9. The method for producing toner according to claim 1, wherein the step (b) comprises aggregating the primary base particles with the base microparticles remaining in the suspension of the primary base particle by heating at a temperature near the glass transition point of the primary base particles.
